(19) United States
(12) Patent Application Publication
(10) Pub. No.: US 2012/0081321 A1
(43) Pub. Date: Apr. 5, 2012

(54) INPUT METHOD AND APPARATUS FOR MOBILE TERMINAL WITH TOUCH SCREEN

(75) Inventor: Kun-Woo BAEK, Gyeongsangbuk-do (KR)

(73) Assignee: Samsung Electronics Co., Ltd., Gyeonggi-Do (KR)

(21) Appl. No.: 13/248,288

(22) Filed: Sep. 29, 2011

(30) Foreign Application Priority Data
Sep. 30, 2010 (KR) 10-2010-0095676

(51) Int. Cl. G06F 3/041

(52) U.S. Cl. 345/173

(57) ABSTRACT

An input method for a mobile terminal with a touch screen is provided. The input method includes switching an operation mode of the mobile terminal to an input mode, and activating and displaying a virtual keypad; recognizing a specific key, from which a user input has occurred, among keys on the displayed virtual keypad; and displaying at least one or more functional objects designated to the recognized key, in a specific region of the virtual keypad.

### CLAIM OF PRIORITY

This application claims the benefit under 35 U.S.C. §119 of a Korean Patent Application filed in the Korean Intellectual Property Office on Sep. 30, 2010 and assigned Serial No. 10-2010-0095676, the entire disclosure of which is hereby incorporated by reference.

### BACKGROUND OF THE INVENTION

1. Field of the Invention

The present invention relates generally to data entry in a mobile terminal, and more particularly, to an input method and apparatus for a mobile terminal with a touch screen, in which a virtual keypad is used for data entry.

2. Description of the Related Art

Mobile terminals have not only the voice call features, but also many other features and functions including MP3, game, and information transmission/storage. To this end, a keypad and a combination of keys used to manipulate these functions is mounted in the mobile terminals.

Recently, a virtual keypad is introduced in a mobile terminal which is equipped with a capacitive/resistive touch screen.

FIGS. 1A to 1C illustrate virtual keypads displayed on a touch screen of the conventional mobile terminal Because the virtual keypads are displayed on the small touch screen rather than the large screens of the personal computers and the game consoles, input errors occur frequently unless users pay special attention during data entry.

In order to selectively input a number and a plurality of English and other language characters mapped to each key, the user must inconveniently switch key input modes several times to select desired capital key, low key, or number key as illustrated in FIGS. 1A to 1C.

### SUMMARY OF THE INVENTION

An aspect of the present invention is to address at least the above-mentioned problems and/or disadvantages and to provide at least the advantages described below. Accordingly, an aspect of the present invention is to provide an input method and apparatus for a mobile terminal with a touch screen, in which one or more functional objects are mapped to each key prepared on a virtual keypad, such that if a user input is detected from a key, each of functional objects mapped to the key is allocated and arranged in a specific region, thus enabling a correct entry of a desired key without switching the key input modes.

In accordance with one aspect of the present invention, an input method for a mobile terminal with a touch screen includes switching an operation mode of the mobile terminal to an input mode, and activating and displaying a virtual keypad; recognizing a specific key, from which a user input has occurred, among keys on the displayed virtual keypad; and displaying at least one or more functional objects designated to the recognized key in a specific region of the virtual keypad.

In accordance with another aspect of the present invention, an input apparatus for a mobile terminal with a touch screen includes a virtual keypad having a combination of keys, to each of which at least one or more functional objects are mapped in a specific key layout; a display displaying a virtual keypad having a combination of a plurality of virtual keys and including an input field in which a user input occurred in the virtual keypad is displayed; and a controller configured to recognize a specific key, from which a user input has occurred, among keys on the virtual keypad displayed on the display and to display at least one or more functional objects designated to the recognized key in a specific region of the virtual keypad.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIGS. 1A to 1C are diagrams illustrating virtual keypads displayed on a touch screen of the conventional mobile terminal with the touch screen;

FIG. 2 is a flowchart illustrating an input method for a mobile terminal with a touch screen according to an embodiment of the present invention;

FIGS. 3A to 3E are screen diagrams illustrating inputs on a screen of a mobile terminal with a touch screen according to an embodiment of the present invention; and

FIG. 4 is a block diagram illustrating a structure of an input device of a mobile terminal with a touch screen according to an embodiment of the present invention.

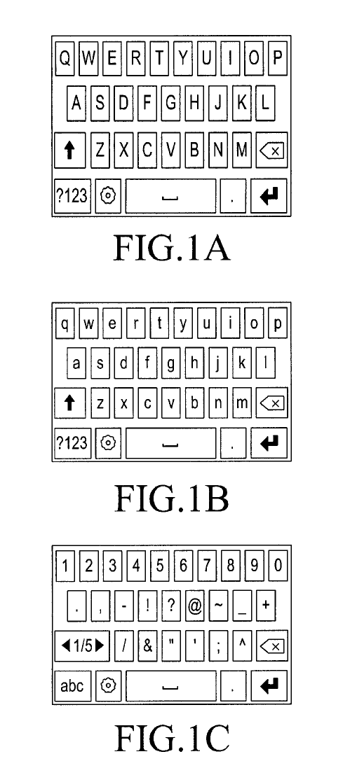

Throughout the drawings, the same drawing reference numerals will be understood to refer to the same elements, features and structures.

### DETAILED DESCRIPTION OF THE INVENTION

Exemplary embodiments of the present invention will now be described in detail with reference to the accompanying drawings. In the following description, specific details such as detailed configuration and components are merely provided to assist the overall understanding of exemplary embodiments of the present invention. Therefore, it should be apparent to those skilled in the art that various changes and modifications of the embodiments described herein can be made without departing from the scope and spirit of the invention. In addition, descriptions of well-known functions and constructions are omitted for clarity and conciseness.

The present invention is directed to allowing a user to easily input language-specific (or country-specific) characters, numbers, and symbols using a virtual keypad displayed on a touch screen in a mobile terminal. In particular, the present invention provides a technology in which one or more functional objects (or function-specific objects), for example, language-specific characters, numbers, special characters, and symbols, are mapped to each key provided on a virtual keypad, so that if a user input is recognized from such a key, each of at least one or more functional objects mapped to the key is allocated and arranged in a specific region, thereby significantly reducing the time required in entering functional objects without mode switching among language-specific characters, numbers, special characters, and symbols. As a result, the user is allowed to easily identify an object he or she wishes to enter or activate, thus enhancing user's convenience.

A mobile terminal with a touch screen, to which an embodiment of the present invention is applicable, may include all information/communication devices and multimedia devices, such as digital broadcasting terminals, Personal Digital Assistants (PDAs), smart phones, and 3^{rd} Generation (3G) terminals (e.g., International Mobile Telecommunication 2000 (IMT-2000) terminals, Wideband Code Division Multiple Access (WCDMA) terminals, Global System for Mobile communication/General Packet Radio Service (GSM/GPRS) terminals, and Universal Mobile Telecommunication Service (UMTS) terminals. It will be apparent to those skilled in the art that the teachings of the present invention may be applied to any applications for these terminals.

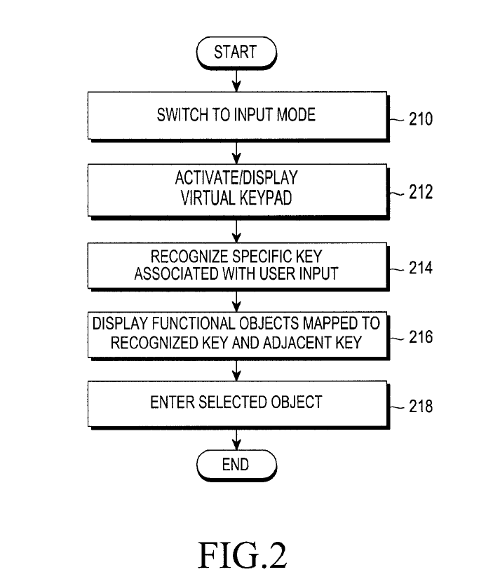

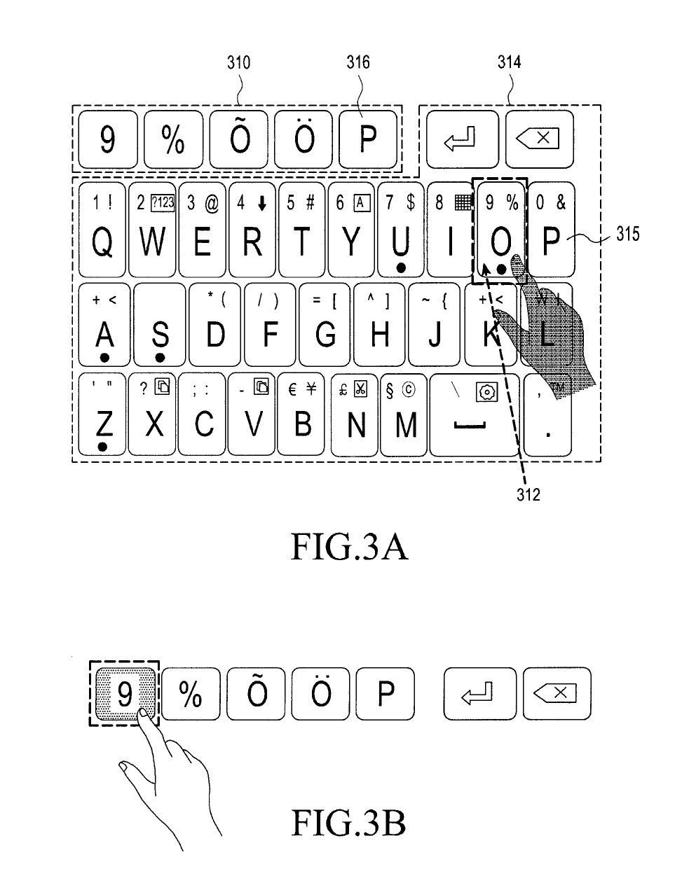

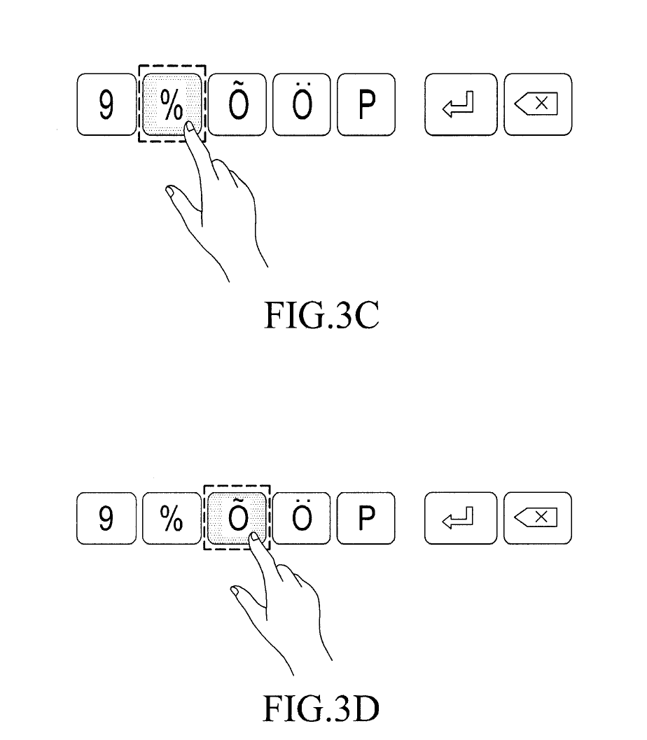

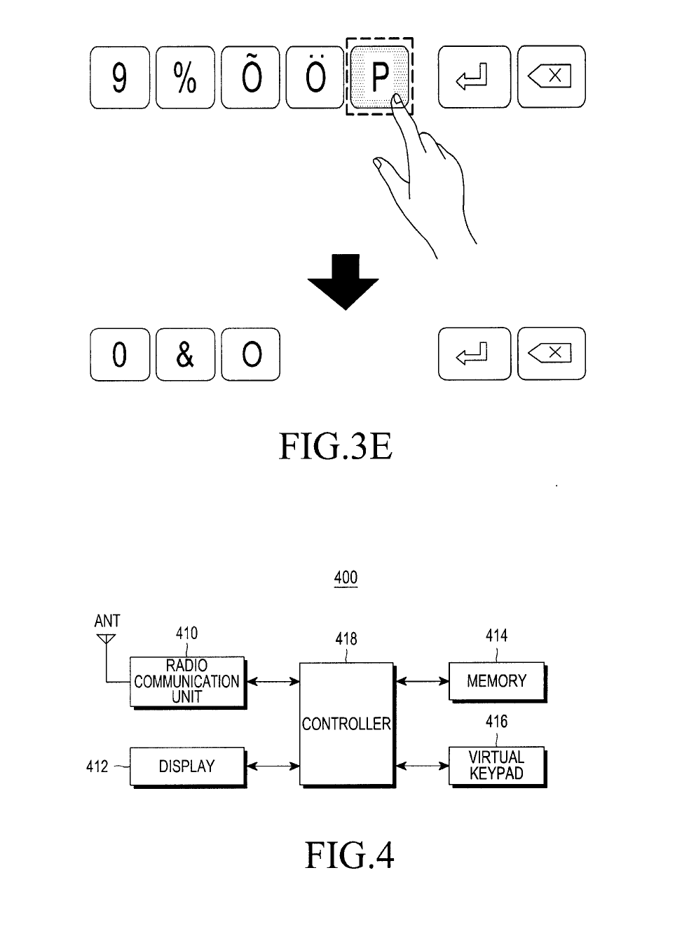

Hereinafter, an input method for a mobile terminal with a touch screen according to an embodiment of the present invention will be described in detail with reference to FIGS. 2 and 3A to 3E.

FIG. 2 illustrates an input method for a mobile terminal with a touch screen according to an embodiment of the present invention.

In step 210, the current operation mode of the mobile terminal is switched to an input mode.

In step 212, a virtual keypad is activated and displayed. The virtual keypad is configured to have the QWERTY key layout. At least one or more functional objects are mapped to each key constituting the virtual keypad. The functional objects mapped to each key may include numbers, language-specific characters, symbols, and special characters.

In step 214, a user input occurs on a specific key of the virtual keypad displayed in step 212 and is recognized. The user input may be recognized by detecting a user contact made by pointing onto the touch screen of the mobile terminal using a user input means such as a finger and a stylus pen.

In step 216, at least one or more functional objects designated to the key recognized in step 214 are displayed in a specific region of the virtual keypad, and the functional objects displayed in the specific region and corresponding to the recognized key are individually allocated and displayed in the same key layout as that of the keys on the virtual keypad. In the specific region of the virtual keypad, in which functional objects mapped to the recognized key are displayed, a character mapped to a key adjacent to the recognized key may be displayed together. A more illustrative example is provided with reference to FIG. 3.

In step 218, any one object selected by the user from among the functional objects displayed in the specific region and corresponding to the specific key, is entered in an input field on a display.

The recognized key, to which at least one or more functional objects are mapped, is displayed on the virtual keypad in an active state until an input completion key is recognized, and the active state is maintained until entry of the functional objects displayed in the specific region is ended.

If a user input has occurred from a character key mapped to the adjacent key displayed together in step 216 in the specific region of the virtual keypad, the specific region is changed to include at least one or more functional objects mapped to the adjacent key.

The operation of steps 210 to 218 will now be described with reference to FIGS. 3A to 3E.

FIG. 3A illustrates a virtual keypad configured to have the QWERTY key layout according to an embodiment of the present invention. The virtual keypad includes a region 314 for recognizing a user input occurred on a specific key 312, and a specific region 310, in which at least one or more functional objects (9, O, %) mapped to the specific key 312 are displayed. That is, upon activation of key 212, the region 310 displays functions objects keys corresponding to the key 312. key 316 in the specific region 310 means a character ‘P’ mapped to a key 315 adjacent to the recognized key 312, and is provided to allow a user to exactly identify the key he or she has selected in order to minimize input errors. It should be noted that the functional keys corresponding to the key 312 is shown in FIG. 31 is for illustrative purposes, so other keys or combination of functional keys can be display in the specific region 310 of the virtual key pad upon activation of a particular key in the region 314. Thus, the drawing should not limit the scope of the invention.

FIGS. 3B, 3C and 3D illustrate an example of a process in which any one object is selected by a user from among functional objects corresponding to the specific key 312 displayed in the specific region 310 of the vertical keypad, and the selected object is activated and entered in an input field on a display.

FIG. 3E illustrates an example in which if a user input occurs on the character key ‘P’ 316 displayed in the specific region 310 of the virtual keypad, the specific region 310 is changed to include at least one or more functional objects mapped to the adjacent key ‘P’ 315, as shown at the bottom of FIG. 3e.

Hereinafter, an input apparatus for a mobile terminal with a touch screen according to an embodiment of the present invention will now be described in detail herein below with reference to FIG. 4.

FIG. 4 illustrates a structure of an input apparatus for a mobile terminal with a 15 touch screen according to an embodiment of the present invention.

Referring to FIG. 4, a mobile terminal 400 with a touch screen includes a radio communication unit 410, a display 412, a memory 414, a virtual keypad 416, and a controller 418.

In operation, the radio communication unit 410 demodulates a radio downlink 20 signal into downlink data, and provides the downlink data to the controller 418. Also, the radio communication unit 410 generates a radio uplink signal by modulating uplink data received from the controller 418, and wirelessly transmits the radio uplink signal over the air using an antenna ANT. Here, the modulation and demodulation may be performed by different protocols, which include Code Division Multiple Access (CDMA), which is 25 replaceable by Frequency Division Multiplexing (FDM) or Time Division Multiplexing (TDM).

The display 412 displays the virtual keypad 416 having a combination of a plurality of virtual keys and includes an input field for displaying a user input on the virtual keypad 416.

The virtual keypad 416 includes keys, to each of which at least one or more functional objects are mapped in the QWERTY key layout.

The memory 414, in which programs for processing and controlling the controller 418 may be stored, stores language-specific characters displayed on the virtual keypad 416.

The controller 418 is configured to recognize a user input on a specific key among keys of the virtual keypad 416 displayed on the display 412 and to display one or more functional objects designated or related to the recognized key in a specific region of the virtual keypad. he controller 418 controls any one object selected by a user from among functional objects corresponding to the specific key, displayed in the specific region, to be entered in the input field on the display 412.

The controller 418 controls a character mapped to a key adjacent to the 10 recognized key to be displayed together in the specific region of the keypad, in which at least one or more functional objects designated to the recognized key are displayed. If a user input occurs on a key mapped to the adjacent key in the specific region, the controller 418 controls at least one or more functional objects mapped to the adjacent key to be displayed in the specific region.

The above-described methods according to the present invention can be implemented in hardware, firmware or as software or computer code that can be stored in a recording medium such as a CD ROM, an RAM, a floppy disk, a hard disk, or a magneto-optical disk or computer code downloaded over a network originally stored on a remote recording medium or a non-transitory machine readable medium and to be stored on a local recording medium, so that the methods described herein can be rendered in such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

As is apparent from the foregoing description, according to an exemplary embodiment of the present invention, a mobile terminal with a touch screen allocates and arranges each of at least one or more functional objects mapped to a specific key in a specific region using a virtual keypad having a combination of keys, to each of which at least one or more functional objects are mapped, thereby significantly reducing the time required in entering functional objects without mode switching and thus allowing the user to easily identify an object he or she wants to enter, minimizing input errors.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An input method for a mobile terminal having a touch screen, comprising:
displaying a virtual keypad during an input mode;
recognizing a specific key activated on the displayed virtual keypad; and
displaying at least one or more functional objects corresponding to the recognized key in a predetermined region of the virtual keypad.

2. The input method of claim 1, wherein the functional objects displayed in the predetermined region is displayed in a same key layout as that of the virtual keypad.

3. The input method of claim 1, wherein any one object activated among the functional objects in the specific region is entered in an input field.

4. The input method of claim 1, wherein the recognized key is displayed on the virtual keypad in an active state until an input completion key is recognized.

5. The input method of claim 1, wherein the predetermined region of the virtual keypad further displays a character key adjacent to the recognized key.

6. The input method of claim 5, wherein the character key in the predetermined region is activated, the predetermined region is further changed to display at least one or more functional objects corresponding to the activated character key.

7. The input method of claim 1, wherein the virtual keypad has a QWERTY key layout.

8. An input apparatus for a mobile terminal having a touch screen, comprising:
a virtual keypad having a plurality of virtual keys, each of the virtual keys having at least one or more functional objects corresponding thereto;
a display displaying the virtual keypad and including an input field for displaying a character activated on the virtual keypad; and
a controller configured to recognize a specific key activated on the virtual keypad and to display at least one or more functional objects corresponding to the recognized key in a predetermined region of the virtual keypad.

9. The input apparatus of claim 8, wherein the controller controls any one object selected activated in the specific region to be entered in the input field for display.

10. The input apparatus of claim 8, wherein the one or more functional objects include numbers, language-specific characters, symbols, and special characters.

11. The input apparatus of claim 8, wherein the controller is configured to display a key adjacent to the recognized key in the specific region of the virtual keypad.

12. The input apparatus of claim 11, wherein the controller controls such that when the key adjacent to the recognized key displayed in the predetermined region is activated, the predetermined region is further changed to display at least one or more functional objects corresponding to the activated key.

13. A mobile terminal having a touch screen, comprising:
a display displaying a virtual keypad having a plurality of virtual keys, each of the virtual keys having at least one or more functional objects corresponding thereto; and
a controller recognizing a specific key activated on the virtual keypad and to display at least one or more functional objects corresponding to the recognized key in a predetermined region of the virtual keypad.

14. The mobile terminal of claim 13, wherein the display further displaying an input field for displaying a character activated on the virtual keypad and on the predetermined region.

15. The mobile terminal of claim 13, wherein the one or more functional objects include numbers, language-specific characters, symbols, and special characters.

16. The mobile terminal of claim 13, wherein the controller displays a key adjacent to the recognized key in the specific region of the virtual keypad.

17. The mobile terminal of claim 14, wherein the controller further changes the predetermined region to display at least one or more functional objects corresponding to the key when the key adjacent to the recognized key displayed in the specific region of the virtual keypad is activated.
